(19) United States
(12) Patent Application Publication
(10) Pub. No.: US 2026/0060263 A1
(43) Pub. Date: Mar. 5, 2026

(54) VACUUM COOLING, CONSTANT FLOW PARTIAL PRESSURE WITHOUT REFRIGERATION

(71) Applicant: Western Precooling Systems, Pleasanton, CA (US)

(72) Inventor: Jeffrey Scott Beebout, Phoenix, AZ (US)

(73) Assignee: Western Precooling Systems, Pleasanton, CA (US)

(21) Appl. No.: 19/313,548

(22) Filed: Aug. 28, 2025

Related U.S. Application Data
(60) Provisional application No. 63/688,810, filed on Aug. 29, 2024.

(51) Int. Cl. A23B 7/04; A23B 2/00; A23B 2/10; A23B 2/80; F25D 3/00

(52) U.S. Cl. CPC A23B 7/0425; A23B 2/001; A23B 2/103; A23B 2/803; A23B 2/805; A23B 7/0408; F25D 3/00

(57) ABSTRACT

A method and apparatus for evaporative cooling of materials within a vacuum chamber by maintaining a controlled partial pressure environment. The method involves sealing material inside a chamber, reducing the internal pressure using a vacuum pump, and simultaneously introducing external gas—such as ambient air, nitrogen, or inert gases—into the chamber. A constant partial pressure is maintained by balancing the gas input and vacuum pump operation, allowing for efficient evacuation of vaporized liquid without recondensation. The system can operate with either constant or variable flow rates for both gas input and vacuum pumping, depending on desired cooling conditions, chamber size, and material characteristics. The apparatus includes a sealable vacuum chamber, at least one external gas inlet, and a vacuum pump configured to sustain the target partial pressure.

### CLAIM OF PRIORITY

This application claims priority to U.S. Provisional Patent Application No. 63/688,810, entitled “Vacuum Cooling, Constant Flow Partial Pressure Without Refrigeration”, filed Aug. 29^{th}, 2024, which application is incorporated by reference herein in its entirety.

### FIELD OF THE INVENTION

The present disclosure relates to technology for vacuum cooling of, but not limited to, produce, bread, other foodstuffs, flowers and industrial applications.

### BACKGROUND

Vacuum cooling is a rapid cooling technique widely used for fresh produce, particularly leafy vegetables like lettuce, spinach, and herbs, but also for some fruits, flowers, bread, and other perishables. The technique also has applications outside of the food and agricultural sectors. The process involves reducing the pressure around a product in a sealed chamber, which causes water on the product to vaporize. The vaporization of water absorbs heat, leading to a rapid cooling effect.

At a point during the vacuum pump down of the chamber, the vapor pressure of water is reached. It is at this point the water inside the chamber begins to change phase from a liquid to a gas (vaporize). At this level of vacuum there is reduced “airflow” to carry the water vapor out of the chamber towards the vacuum pump, allowing the water vapor to condense onto the vacuum tube walls or even back onto the product itself. As the water vaporizes it also raises the pressure inside the chamber. If the pressure rises above the vapor pressure of the water, it will stop the vaporization and subsequently the cooling effect, until the vacuum pump can catch up with the increased water vapor load and reduce the pressure in the vacuum tube back down to the vapor pressure of the water. The vacuum systems utilized cannot handle the water vapor load created by this process. To address this issue refrigerated coils (Meissner Trap) are placed on the interior ceiling of the chamber in front of the vacuum pump line penetrations. The coils, almost exclusively cooled with Ammonia, are used to condense the water vapor, lowering the pressure within the chamber as well as reducing the water vapor load on the vacuum system. The water vapor is condensed, and frozen to the coils until the process is complete. The chamber is then brought to atmospheric pressure, and the coils start to defrost. Since throughput is a major consideration in most operations, minimal time is allotted between cooling runs, as a result, the coils are at risk of not fully defrosting before the next run is initiated. This means the possibility of coils starting the next run with a large portion of their surface area already being taken up with leftover water and/or ice. A problem that can compound with each run.

In an attempt to maintain vacuum levels near the target level an air vent valve, commonly referred to as a “bounce valve” is utilized. This valve lets unmetered outside air enter the chamber when activated. By measuring the vacuum level in the chamber and opening the valve when the vacuum level is at its low setpoint, the internal chamber pressure is raised until the high setpoint is reached, at which point the valve is closed. This bouncing sequence is repeated over and over during the cooling process. The setpoints are a compromise; set to avoid freezing on the low side and to keep within the limit of vapor pressure for the high side. This technique is used in conjunction with a refrigerated coil mounted inside the chamber that captures and traps the water vapor created by the vaporization process preventing it from reaching the vacuum system.

### SUMMARY

One general aspect includes a method for evaporative cooling of material. The method includes loading material to be cooled into a sealable chamber and sealing the chamber. The method also includes pumping atmosphere within the chamber to reduce pressure in the chamber using a vacuum pump. The method also includes inputting external gas from outside the sealed chamber into the chamber and continuing to pump atmosphere from the chamber while maintaining a constant partial pressure using a combination of the external gas input and vacuum pump, where the partial pressure is selected based on pump capacity, to provide sufficient partial pressure to evacuate vaporized liquid from the chamber, such that any vaporized liquid is removed from the chamber.

Implementations may include the method where inputting external gas from outside the sealed chamber may include inputting gas at a constant flow. Implementations may include the method including inputting external gas outside the sealed chamber may include varying the flow rate of the external gas in order to maintain the constant partial pressure. Implementations may include the method including maintaining by varying the vacuum pumping speed or flow volume relative to a flow rate of the external gas input. The maintaining may include using static vacuum pumping speed, and static exterior gas flow rate selected to cool the material to a desired temperature, the speed and flow rate selected based on the cooling material, chamber size and pump composition. Implementations may include the method including inputting external gas may include one of ambient air, nitrogen or other gases. Implementations may include the method including inputting external gas may include inputting external gas at one or more input locations within the chamber. Implementations may include the method including removing any condensed liquid from the chamber at one or more different output locations within the chamber.

Another aspect includes an apparatus for vacuum cooling of a material. The apparatus includes a sealable vacuum chamber; at least one external gas inlet; and a vacuum pump having sufficient capacity such that the pump in combination with a volume of gas passing through the external gas inlet maintains a constant partial pressure in the chamber, where the partial pressure is selected based on pump capacity, to provide sufficient flowrate to evacuate vaporized water from the chamber.

Implementations may include the apparatus where the apparatus includes an external gas inlet valve having a constant flow rate which inputs gas at a constant flow. Implementations may include the apparatus where the apparatus includes an external gas inlet valve having a controllable, variable flow rate of the external gas in order to maintain the constant partial pressure. Implementations may include the apparatus where the vacuum pump includes a controllable variable vacuum pumping speed or flow volume relative to a flow rate of the external gas input. Implementations may include the apparatus where the apparatus includes an external gas inlet valve having a constant flow rate which inputs gas at a constant flow, the vacuum pump has a constant speed, and the speed and flow rate selected based on the material to be cooled, chamber size and pump composition. Implementations may include the apparatus where external gas may include one of ambient air, nitrogen or other gases. Implementations may include the apparatus where the apparatus including an external gas manifold having a plurality of inlets within the chamber such that the external gas is input at one or more input locations within the chamber, simultaneously or at intervals. Implementations may include the apparatus where the apparatus further including an external gas manifold having a plurality of outlets within the chamber such that one or more different output locations for vaporized liquid are provided within the chamber. Implementations may include the apparatus where the external gas manifold is configured to provide a venturi flow effect between the plurality of outlets and the vacuum pump.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Aspects of the present disclosure are illustrated by way of example and are not limited by the accompanying figures for which like references indicate the same or similar elements.

FIG. 1 depicts a prior art evaporative water-cooling method.

FIG. 2 is a flowchart depicting an evaporative water-cooling method in accordance with the disclosed technology.

FIG. 3 is a block diagram of an apparatus of the disclosed technology.

FIG. 4 is a flowchart depicting a further evaporative water-cooling method in accordance with the disclosed technology.

FIG. 5 is a flowchart depicting another evaporative water-cooling method in accordance with the disclosed technology.

FIG. 6 is a flowchart depicting yet another evaporative water-cooling method in accordance with the disclosed technology.

FIG. 7 is a diagram of an apparatus chamber suitable for use in embodiments of the disclosed technology.

### DETAILED DESCRIPTION

A vacuum cooling process and apparatus that eliminates the need for refrigeration coils located in the vacuum chamber as a component of water vapor removal is disclosed. The disclosed technology eliminates the need for refrigerated coils by creating and maintaining a steady, constant vacuum partial pressure with no bouncing between hi/low setpoints. The technology maintains this constant partial pressure at the ideal vacuum level using a variety of techniques, including a managed leak of outside air resulting in an increased, constant flow of air through the chamber, thereby increasing the volume and efficiency of water vapor transport out of the chamber. In certain embodiments with certain vacuum pump technologies, a water vapor separator, or similar device, can be utilized on the vacuum pump line to remove a portion of the water vapor prior to entering the vacuum pump. Although embodiments of the disclosure discuss applications with respect to products such as produce, it should be understood that the applications of the disclosed technology are not limited to cooling produce.

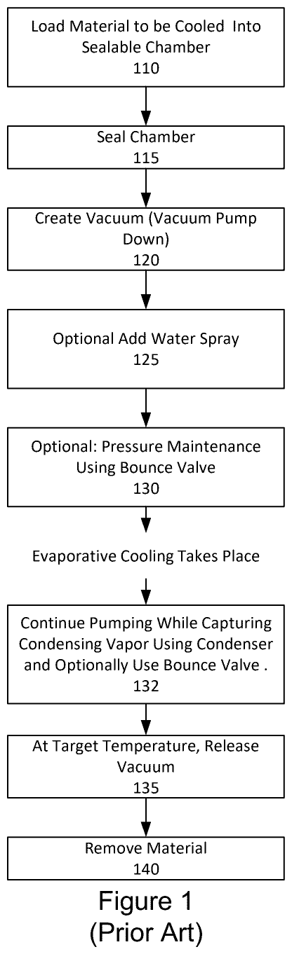

FIG. 1 illustrates a conventional evaporative cooling process. At 110, material to be cooled may be loaded into a vacuum chamber. In some applications, for example, this includes loading freshly harvested produce on one or more pallets into a sealable chamber, also referred to herein as a vacuum tube. The produce is often packed in perforated containers to allow for efficient cooling. At 115, the chamber is sealed. In the context of this disclosure, sealed chambers may refer to completely sealed chambers (such that no external air source is allowed into the chamber) or chambers having a bounce valve, allowing periodic inlet of unregulated air into the chamber interior. At 120, vacuum pump down occurs to create vacuum within the chamber. The vacuum pump is used to reduce the air pressure inside the chamber, and this lowering of pressure decreases the temperature of the boiling point of water (vapor pressure). As the pressure drops, water on the surface of the produce begins to vaporize rapidly. This vaporization process absorbs heat, effectively cooling the produce. Optionally, at 125, before the start of the pump down process, water is sprayed onto the material to facilitate more vaporization, enhancing the cooling effect. This is particularly useful for produce having low surface moisture.

Pumping continues at 132 to maintain vacuum in the chamber and cool the material to a desired temperature. At a point during the vacuum pump down of the chamber, the vapor pressure of water is reached. At this point the water inside the chamber begins to change phase from a liquid to a gas (vaporize). At this level of vacuum there is reduced “airflow” to carry the water vapor out of the chamber towards the vacuum pump, allowing the water vapor to condense onto the vacuum tube walls or even back onto the produce itself. As the water vaporizes it also raises the pressure inside the chamber. If the pressure rises above the vapor pressure of the water, it will stop the vaporization and subsequently the cooling effect, until the vacuum pump can catch up with the increased water vapor load and reduce the pressure in the vacuum tube back down to the vapor pressure of the water. The vacuum systems utilized cannot handle the water vapor load created by this process. To address this issue, a condenser, for example refrigerated coils or a Meissner trap, may be placed on the interior ceiling of the chamber in front of the vacuum pump line penetrations. The coils, almost exclusively cooled with ammonia, are used to condense the water vapor, lowering the pressure within the chamber as well as reducing the water vapor load on the vacuum system. The water vapor is condensed, and frozen to the coils until the process is complete. The chamber is then brought to atmospheric pressure, and the coils start to defrost. Since throughput is a major consideration in most operations, minimal time is allotted between cooling runs, as a result, the coils are at risk of not fully defrosting before the next run is initiated. This means the possibility of coils starting the next run with a large portion of their surface area already being taken up with leftover water and/or ice. A problem that can compound with each run.

Optionally, at 132, a bounce valve is used. in an attempt to maintain vacuum levels near the target level. This valve lets unmetered outside air enter the chamber when activated. By measuring the vacuum level in the chamber and opening the valve when the vacuum level is at its low setpoint, the internal chamber pressure is raised until the high setpoint is reached, at which point the valve is closed. This bouncing sequence is repeated over and over during the cooling process. The setpoints are a compromise; set to avoid freezing on the low side and to keep within the limit of vapor pressure for the high side. This technique is used in conjunction with a refrigerated coil mounted inside the chamber that captures and traps the water vapor created by the vaporization process preventing it from reaching the vacuum system.

At a target temperature, at 140, the vacuum in the chamber is released. At 145, cooled material is removed from the chamber for further processing.

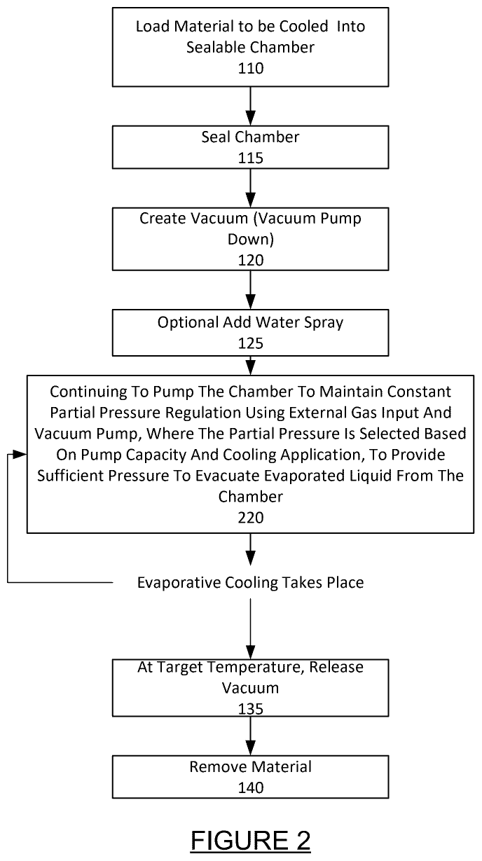

FIG. 2 illustrates a method in accordance with present disclosure. The method eliminates the need for a condenser and increased throughput in vacuum cooling operations. In FIG. 2, like numbers represent like steps to those in FIG. 1. After vacuum pumping commences, at 220, pressure within the chamber is regulated to maintain a partial pressure within the chamber at ideal levels.

In particular, at 220, constant partial pressure is regulated using an external air (or external gas) input (or inputs) and a vacuum pump, where the constant partial pressure may be selected based on pump capacity and the cooling application (the temperature to which the material is to be cooled and the material itself), to provide sufficient flowrate to evacuate vaporized water from the chamber. In embodiments, this can comprise using a metered, control valve. In other embodiments, this partial pressure is maintained using a steady state flow valve designed for the application, or multiple flow valves.

This constant partial pressure is targeted to comprise an ideal vacuum level to result in an increased, constant flow of air through the chamber, thereby increasing the volume and efficiency of water vapor transport out of the chamber. In embodiments, a water vapor separator, or similar device, can be utilized on the vacuum pump line to remove a portion of the water vapor prior to entering the vacuum pump if desired. The method eliminates the need for a condenser coil to remove evaporated water from the system, greatly increasing the throughput of product cooling.

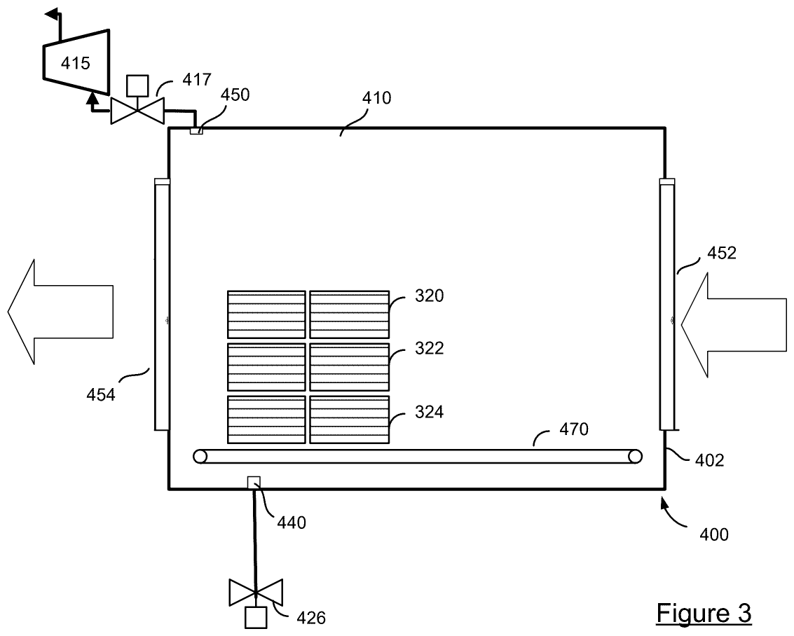

FIG. 3 illustrates an apparatus suitable for implementing the processes discussed above. The 400 apparatus comprises chamber 402 having sufficient capacity to hold at least one, and in other embodiments many, material containers 320, 322, 324 of any material to be cooled. This chamber facilitates isolation by a load door 452 used for incoming material and a second door 454 used for removing cooled material. A conveyor system 470 (or shuttle system) may be provided to move containerized or palletized material from one end of the chamber to the other once loaded into the chamber.

An external air (or gas) inlet valve 426 may be used to provide external air into the interior 410 of chamber 402 through an input port 440 to maintain the constant partial pressure. A vacuum pump 415 (and control valve 417) may be provided to allow for evacuation of the chamber 402 via an outlet port 450 in accordance with the foregoing processes. 400 vacuum pumps suitable for use in the present system include rotary vane and dry screw pumping technologies.

Notably, the apparatus of FIG. 3 does not include a condenser or bounce valve and provides for reduced power consumption.

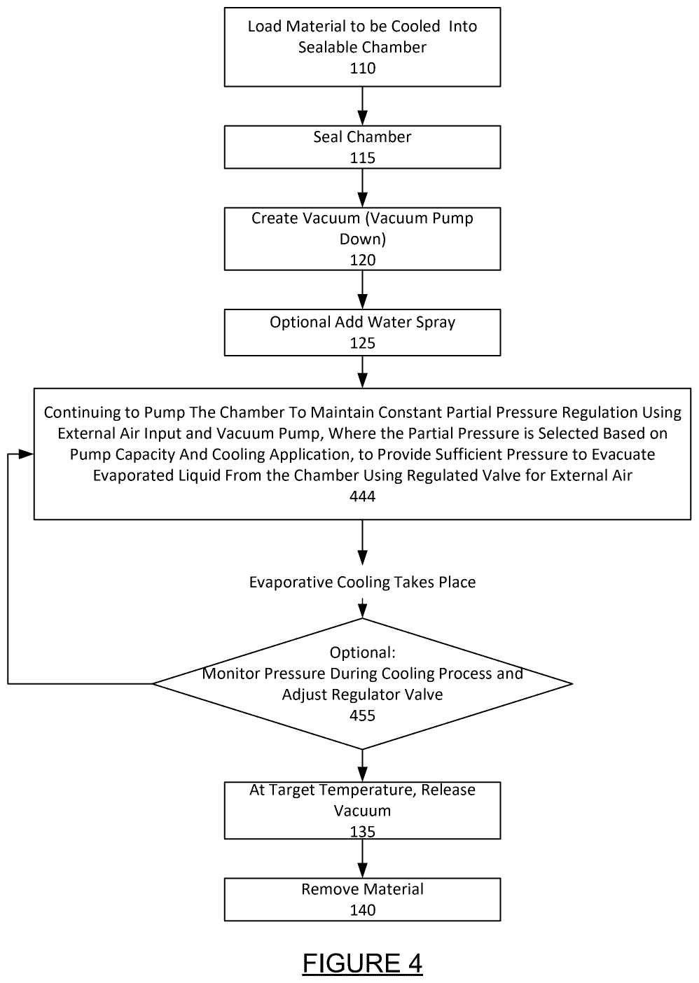

FIG. 4 illustrates an alternative process in which like steps having the same reference numbers are equivalent to those in FIG. 2. In the process of FIG. 4, at 444, constant partial pressure regulation using external air input and a vacuum pump, where the partial pressure is selected based on pump capacity and the cooling application, to provide sufficient flowrate to evacuate vaporized water from the chamber, is performed using a control valve whose flow is adjustable to input external air. In the context of apparatus 400, this includes using a metered valve for valve 426. Optionally, at 455, one may monitor the partial pressure in the chamber and adjust the valve in real time to optimize the constant partial pressure.

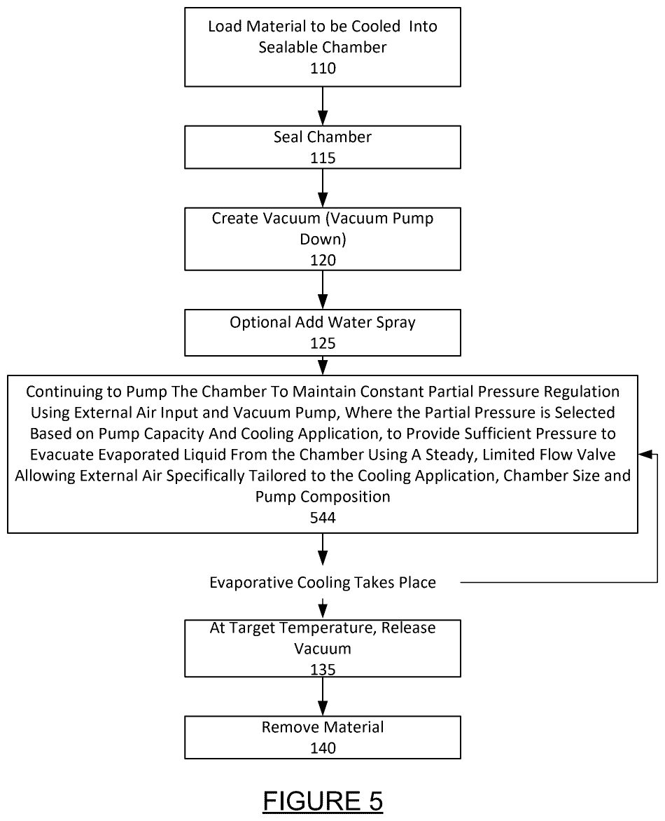

FIG. 5 illustrates an alternative process in which like steps having the same reference numbers are equivalent to those in FIG. 2. In the process of FIG. 5, at 544, constant partial pressure regulation using external air input and a vacuum pump, where the partial pressure is selected based on pump capacity and the cooling application, to provide sufficient flowrate to evacuate vaporized water from the chamber, is performed using a steady, limited flow valve allowing external air specifically tailored to the cooling application, chamber size and pump composition. In the context of apparatus 400, this includes using a steady flow valve for valve 426 and a steady rate vacuum pump. In this embodiment, the flow rate of the valve, chamber volume, target temperature, and pump capacity are all selected for a particular application of cooling a specific material to a specific temperature.

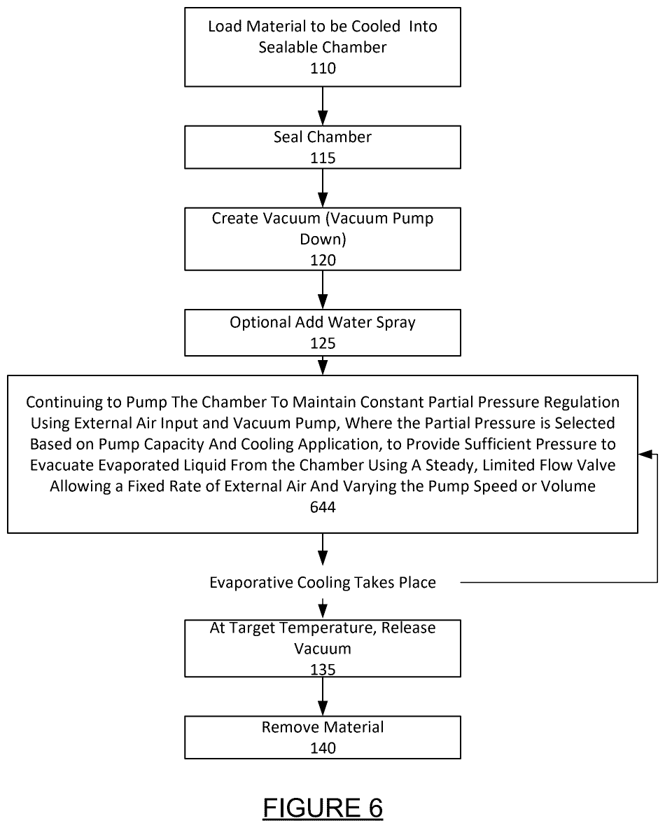

FIG. 6 illustrates an alternative process in which like steps having the same reference numbers are equivalent to those in FIG. 2. In the process of FIG. 6, at 644, constant partial pressure regulation using external air input and a vacuum pump, where the partial pressure is selected based on pump capacity and the cooling application, to provide sufficient flowrate to evacuate vaporized water from the chamber, is performed using a steady, limited flow valve allowing a fixed rate of external air and varying the pump speed or volume. In the context of apparatus 400, this includes using a steady flow valve for valve 426. In this embodiment, the flow rate of the valve is constant, but a variable speed vacuum pump can be adjusted to change and optimize the constant partial pressure in the chamber. In embodiments, a feedback step such as step 455 may be used to provide real-time feedback to the operator, or control system, to maintain the constant partial pressure at an optimized level.

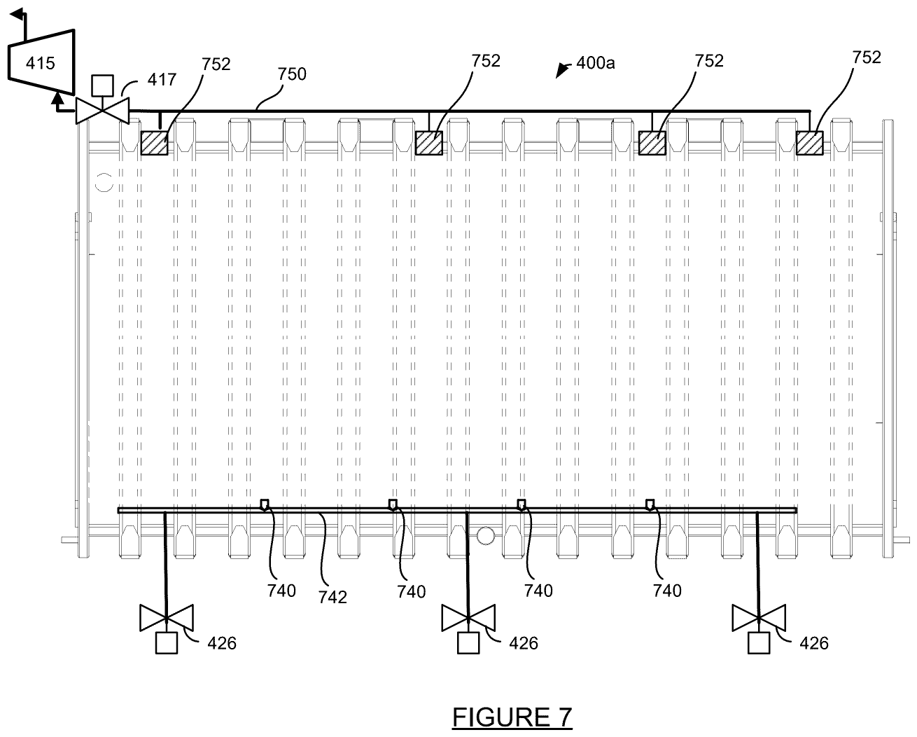

FIG. 7 illustrates a further embodiment of a chamber 400a. In the embodiment of FIG. 7, multiple external air inlet valves 426 are shown feeding multiple, spaced air chamber inlets 740. The inlets are connected by a manifold 742. Also shown are multiple outlet ports 752 coupled by a common vacuum manifold 750 leading to vacuum pump 415. It should be understood that the number of inlets 740 and outlet ports 752, and their relative position within the chamber, can be optimized based on the application for which the chamber is being utilized, as well as the size of the chamber and the type and performance of the vacuum pump utilized.

Various combinations of the above embodiments may be utilized without departing from the scope of the technology.

In embodiments, a system for vacuum cooling comprises a vacuum chamber with vacuum pump out ports and external air inlets, the quantity of which, and the position of which, optimize the flow of air, or gas, through the chamber to extract the maximum amount water vapor from the chamber. The position and quantity of false air inlets and vacuum pump out ports can be implemented in such a way that reconfiguring their quantity, and position, is possible for products that require a different layout for optimum water vapor removal.

In embodiments, a system for vacuum cooling comprises a vacuum chamber, an internal water application delivery system (optional), and a vacuum pump with speed control. A common speed control vacuum pump comprises variable speed drive (VSD) or variable frequency drive (VFD) pump. By controlling the speed of the vacuum pump, the flowrate, as well as the vacuum level generated by the vacuum pump, can be controlled. This can then be used to regulate the vacuum level in the chamber to match the vapor load and false air load and maintain the desired vacuum level within the chamber. The false air supply can be ambient, or cooled, with flow/pressure control being automated or manually metered.

Embodiments of the technology further include using vacuum line throttling valve (i.e. valve 417) to adjust tube vacuum level using static false air flowrate and static vacuum flowrate/pumping speed (as in the embodiment of FIG. 5).

In embodiments, the external air supply is ambient air, or a gas other than air. In embodiments, the external air valves 426 may comprise a vacuum regulator or flowmeter. In embodiments, the step of adding additional water spray at 125 comprises the in-situ application of a uniform, precise amount of water to a product, causing the vaporization process to occur immediately upon surface wetting, the frequency and duration of which are not limited. The surface wetting could also be continuous.

In embodiments, real-time monitoring step 455 may comprise monitoring of water vapor volume, and/or flow, and/or temperature to determine cooling process parameters. For instance, if the product enters the chamber at different temperatures, one could determine the temperature of the product by the pressure level that vaporization begins. The pressure in the chamber can then be adjusted to closely match the cooling rate of the product based on its thermal conductivity. Since water vapor occupies more space at lower pressures, by removing the available water vapor before lowering the chamber pressure it would increase pumping efficiency. Combining this with monitoring of the pressure level within the chamber gives the ability to determine when the product has reached its target temperature at which time the cooling cycle can be concluded. If a target vacuum level, which corresponds to a predetermined vapor pressure temperature, is held within the chamber and there is a significant drop in the amount of water vapor being pumped from the chamber, one could surmise the product temperature and the vapor pressure are at equilibrium, vaporization has stopped, and the target product temperature has been reached.

In embodiments, the vacuum manifold 750 and/or ports 752 may be designed to create a venturi effect in the pumped matter from the chamber. This lowers the temperature of the vacuum stream enough to re-condense the water vapor that has been removed from the chamber and has been shown to effectively reduce the volume required to pump by a factor of 1600× or greater depending on vacuum levels.

Experiments were conducted to demonstrate the effects of modulating the external air input from nearly 0 cfm to short bursts of >100 cfm. Results showed that 20-30 scfm was a good range for a chamber having a volume of approximately 1250 cubic feet using product surface area of available water. With 20-30 scfm of external air input, pumping of greater than greater than 2000 lbs/hr of water vapor was achieved, while the water vapor flow dropped to less than 20 lbs/hr with the external air valve closed. The experiments were conducted using a single ½″ ball valve as the external air inlet (as valve 426, for example) for the inputs below 30 cfm and opening an additional 2″ valve partially, to achieve the external air inputs in the 100 scfm range. The data shows hysteresis between the changes in variables and the results, especially at different pressures and whether the external air flow is being reduced or increased.

In embodiments, the application of a uniform, precise amount of water may be applied to a product during the vaporization process which causes the vaporization process to occur immediately upon surface wetting, the frequency and duration of which are not limited. The surface wetting could be continuous or discontinuous. Product processing could be batch type, as described previously for produce cooling, or continuous as you would see on a conveyor type application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Although the present disclosure has been described with reference to specific features and embodiments thereof, it is evident that various modifications and combinations can be made thereto without departing from the scope of the disclosure. The specification and drawings are, accordingly, to be regarded simply as an illustration of the disclosure as defined by the appended claims, and are contemplated to cover any and all modifications, variations, combinations, or equivalents that fall within the scope of the present disclosure.

It is understood that the present subject matter may be embodied in many different forms and should not be construed as being limited to the embodiments set forth herein. Rather, these embodiments are provided so that this subject matter will be thorough and complete and will fully convey the disclosure to those skilled in art. Indeed, the subject matter is intended to cover alternatives, modifications, and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for evaporative cooling of material, comprising:
loading material to be cooled into a sealable chamber;
sealing the chamber;
pumping atmosphere within the chamber to reduce pressure in the chamber using a vacuum pump;
inputting external gas from outside the sealed chamber into the chamber, and
continuing to pump atmosphere from the chamber while maintaining a constant partial pressure using a combination of the external gas input and vacuum pump, where the partial pressure is selected adjusted based on pump capacity, to provide sufficient flowrate to evacuate vaporized liquid from the chamber, such that any vaporized liquid is removed from the chamber.

2. The method of claim 1 wherein inputting an external gas from outside the sealed chamber comprises inputting gas at a constant flow.

3. The method of claim 1 wherein inputting external gas from outside the sealed chamber comprises varying a flow rate of the external gas in order to maintain the constant partial pressure.

4. The method of claim 1 wherein the maintaining comprises varying the vacuum pumping speed or flow volume relative to a flow rate of the external gas input.

5. The method of claim 1 wherein the maintaining comprises using a static vacuum pumping speed, and static exterior gas flow rate selected to cool the material to a desired temperature, the speed and flow rate selected based on the cooling material, chamber size and pump composition.

6. The method of claim 1 wherein the inputting external gas comprises one of ambient air, nitrogen or other gases.

7. The method of claim 1 wherein the inputting external gas comprises inputting external gas at one or more input locations within the chamber.

8. The method of claim 1 further including removing any vaporized liquid from the chamber at one or more different output locations within the chamber.

9. The method of claim 1 further including applying a uniform amount of water to the material in an amount sufficient to at least cause the vaporization process to occur immediately upon surface wetting.

10. An apparatus for vacuum cooling of a material, comprising:
a sealable vacuum chamber;
at least one external gas inlet; and
a vacuum pump having sufficient capacity such that the pump in combination with a volume of gas passing through the external gas inlet maintains a constant partial pressure in the chamber, where the partial pressure is selected based on pump capacity, to provide sufficient flowrate to evacuate vaporized water from the chamber.

11. The apparatus of claim 10 wherein the apparatus includes an external gas inlet valve having a constant flow rate which inputs gas at a constant flow.

12. The apparatus of claim 10 wherein the apparatus includes an external gas inlet valve having a controllable, variable flow rate of the external gas in order to maintain the constant partial pressure.

13. The apparatus of claim 10 wherein the vacuum pump includes a controllable variable vacuum pumping speed or flow volume relative to a flow rate of the external gas input.

14. The apparatus of claim 10 wherein the apparatus includes an external gas inlet valve having a constant flow rate which inputs gas at a constant flow, the vacuum pump has a constant speed, and the speed and flow rate selected based on the material to be cooled, chamber size and pump composition.

15. The apparatus of claim 10 wherein the external gas comprises one of ambient air, nitrogen or other gases.

16. The apparatus of claim 10 including an external gas manifold having a plurality of inlets within the chamber such that the external gas is input at one or more input locations within the chamber.

17. The apparatus of claim 10 further including an vacuum manifold having a plurality of outlets within the chamber such that one or more different output locations for vaporized liquid are provided within the chamber.

18. The apparatus of claim 17 wherein the external gas manifold is configured to provide a venturi flow effect between the plurality of outlets and the vacuum pump to actively cool the vacuum stream.

19. The apparatus of claim 10 wherein no condenser is provided in the interior of the chamber.

20. The apparatus of claim 10 further including a batch processing or continuous conveyor system.
